(19) United States
(12) Patent Application Publication
(10) Pub. No.: US 2013/0151133 A1
(43) Pub. Date: Jun. 13, 2013

(54) SYSTEM AND METHOD FOR PLANNING MOVEMENT OF VEHICLES

(71) Applicant: Joel Kickbusch, Melbourne, FL (US)

(72) Inventor: Joel Kickbusch, Melbourne, FL (US)

(21) Appl. No.: 13/315,909

(22) Filed: Dec. 9, 2011

(51) Int. Cl. G08G 9/00

(52) U.S. Cl. 701/117

(57) ABSTRACT

A method includes determining an operational parameter of a first vehicle traveling with a plurality of vehicles in a transportation network and/or a route in the transportation network, identifying a failure condition of the first vehicle and/or the route based on the operational parameter, obtaining plural different sets of remedial actions that dictate operations to be taken based on the failure condition, simulating travel of the plurality of vehicles in the transportation network based on implementation of the different sets of remedial actions, determining potential consequences on travel of the plurality of vehicles in the transportation network when the different sets of remedial actions are implemented in the travel that is simulated, and, responsive to the potential consequences, receiving a selection of at least one of the different sets of remedial actions to be implemented in actual travel of the plurality of vehicles in the transportation network.

### BACKGROUND

A transportation network for vehicles can include several interconnected routes on which the vehicles travel between locations. For example, a transportation network may be formed from interconnected railroad tracks with rail vehicles traveling along the tracks. The vehicles may travel according to schedules that dictate where and when the vehicles are to travel in the transportation network.

As the vehicles travel in the transportation network, one or more events may occur that cause a slowdown in travel of the vehicles, such as mechanical problems with the vehicles, damage to the routes of the transportation network, gridlock (e.g., a traffic jam) of the vehicles, and the like. When such events occur, some network planning systems allow an operator to re-route or otherwise change how the vehicles travel in the transportation network in an effort to increase the flow of movement of the vehicles or eliminate the gridlock.

Some network planning systems provide the operator with workflows, or standard operating procedures, for responding to different causes of slowdowns in travel. These workflows may include changes to the movements of the vehicles as directed by the operator. One problem with some network planning systems is that the operator is restricted to only implementing a single workflow based on a cause of a slowdown, without regard to the actual impact of implementing the changes directed by the workflow. Another problem is that the operator may not be provided with several options of which workflow to select for implementation. Thus, the operator may have no choice but to use the workflow associated with the cause of the slowdown.

A need exists for systems and methods that can provide network planning systems with more information on the potential impacts of implementing the changes in travel dictated by workflows or standard operating procedures when a cause of the slowdown is identified. Additionally, a need exists for the network planning system to have options as to which workflows or standard operating procedures may be implemented.

### BRIEF DESCRIPTION

In one embodiment, a method (such as a method for planning travel of vehicles in a transportation network) is provided that includes determining an operational parameter of at least one of a first vehicle traveling with a plurality of vehicles in a transportation network or a route in the transportation network, identifying a failure condition of the at least one of the first vehicle or the route based on the operational parameter, obtaining plural different sets of remedial actions that dictate operations to be taken based on the failure condition, simulating travel of the plurality of vehicles in the transportation network based on implementation of the different sets of remedial actions, determining potential consequences on travel of the plurality of vehicles in the transportation network when the different sets of remedial actions are implemented in the travel that is simulated, and, responsive to the potential consequences, receiving a selection of at least one of the different sets of remedial actions to be implemented in actual travel of the plurality of vehicles in the transportation network.

In another embodiment, a system (such as a system for planning travel of vehicles in a transportation network) is provided that includes an identification module, an evaluation module, and a selection module. As used herein, the terms “unit” or “module” include a hardware and/or software system that operates to perform one or more functions. For example, a unit or module may include one or more computer processors, controllers, and/or other logic-based devices that perform operations based on instructions stored on a tangible and non-transitory computer readable storage medium, such as a computer memory. Alternatively, a unit or module may include a hard-wired device that performs operations based on hard-wired logic of a processor, controller, or other device. In one or more embodiments, a unit or module includes or is associated with a tangible and non-transitory (e.g., not an electric signal) computer readable medium, such as a computer memory. The units or modules shown in the attached figures may represent the hardware that operates based on software or hardwired instructions, the computer readable medium used to store and/or provide the instructions, the software that directs hardware to perform the operations, or a combination thereof.

The identification module is configured to determine a failure condition of at least one of a first vehicle of a plurality of vehicles traveling in a transportation network or a route in the transportation network. The failure condition is based an operational parameter of the at least one of the first vehicle or the route. The evaluation module is configured to obtain plural different sets of remedial actions that dictate operations to be taken based on the failure condition. The evaluation module also is configured to simulate travel of the plurality of vehicles in the transportation network based on implementation of the different sets of remedial actions and to determine potential consequences on travel of the plurality of vehicles in the transportation network when the different sets of remedial actions are implemented in the travel that is simulated. The selection module is configured to receive a selection of at least one of the different sets of remedial actions to be implemented in actual travel of the plurality of vehicles in the transportation network based on the potential consequences associated with the different sets of remedial actions.

In another embodiment, another system (such as another system for planning travel of vehicles in a transportation network) is provided that includes an identification module, an evaluation module, and a selection module. The identification module is configured to receive operational parameters of at least one of a first vehicle in a plurality of vehicles traveling in a transportation network or a route in the transportation network from one or more sensors disposed on-board the first vehicle or disposed alongside the route. The identification module also is configured to determine a failure condition of at least one of the first vehicle or the route. The evaluation module is configured to obtain a first set of remedial actions and a second set of remedial actions that can be implemented in response to the failure condition that is identified. The first set of remedial actions and the second set of remedial actions dictate different changes on travel of the plurality of vehicles in the transportation network. The evaluation module also is configured to simulate travel of the plurality of vehicles in the transportation network based on implementation of the first set of remedial actions and based on implementation of the second set of remedial actions. The selection module is configured to receive a selection of at least one of the first set of remedial actions or the second set of remedial actions to be implemented in actual travel of the plurality of vehicles in the transportation network based on a comparison of the travel that is simulated by implementing the first set of remedial actions and the travel that is simulated by implementing the second set of remedial actions.

In another embodiment, another system (e.g., a system for planning movement of vehicles) is provided. The system includes an identification module, an evaluation module, and a selection module. The identification module is configured to determine whether information relating to a first vehicle of a plurality of vehicles in a transportation network, or a route of the transportation network, meets one or more designated criteria for implementing remediation. The evaluation module is configured to obtain plural different remediation plans, responsive to determining that the information meets the one or more designated criteria, implement the remediation plans in simulated travel of the plurality of vehicles in the transportation network, and determine simulated changes in transportation network throughput as a result of implementing the remediation plans in the simulated travel. The selection module is configured to receive a selected one of the remediation plans, for implementation in controlling actual travel of the plurality of vehicles, responsive to the simulated changes in transportation network throughput.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of one embodiment of a transportation network,

FIG. 2 is a flowchart of one embodiment of a method for planning movements of vehicles traveling in a transportation network;

FIG. 3 is a schematic diagram of the transportation network shown in FIG. 1 during a simulation of travel of vehicles according to a first set of remedial actions in accordance with a first example;

FIG. 4 is a schematic diagram of the transportation network shown in FIG. 1 during a simulation of travel of vehicles according to the first set of remedial actions in accordance with the first example;

FIG. 5 is a schematic diagram of the transportation network shown in FIG. 1 during a simulation of travel of vehicles according to the first set of remedial actions in accordance with a second example;

FIG. 6 is a schematic diagram of the transportation network shown in FIG. 1 during a simulation of travel of vehicles according to the first set of remedial actions in accordance with the second example;

FIG. 7 is a schematic diagram of the transportation network shown in FIG. 1 during a simulation of travel of vehicles according to the first set of remedial actions in accordance with a third example;

FIG. 8 is a schematic diagram of the transportation network shown in FIG. 1 during a simulation of travel of vehicles according to the first set of remedial actions in accordance with the third example;

FIG. 9 is a schematic diagram of the transportation network shown in FIG. 1 during a simulation of travel of vehicles according to a second set of remedial actions in accordance with a fourth example;

FIG. 10 is a schematic diagram of the transportation network shown in FIG. 1 during a simulation of travel of vehicles according to the second set of remedial actions in accordance with the fourth example;

FIG. 11 is a schematic diagram of the transportation network shown in FIG. 1 during a simulation of travel of vehicles according to the second set of remedial actions in accordance with a fifth example;

FIG. 12 is a schematic diagram of the transportation network shown in FIG. 1 during a simulation of travel of vehicles according to the second set of remedial actions in accordance with the fifth example;

FIG. 13 is a schematic diagram of the transportation network shown in FIG. 1 during a simulation of travel of vehicles according to the second set of remedial actions in accordance with a sixth example;

FIG. 14 is a schematic diagram of the transportation network shown in FIG. 1 during a simulation of travel of vehicles according to the second set of remedial actions in accordance with the sixth example;

FIG. 15 is a schematic diagram of one embodiment of a planner system shown in FIG. 1;

FIG. 16 is a schematic diagram of one example of a vehicle shown in FIG. 1; and

FIG. 17 is a schematic diagram of one embodiment of a wayside device shown in FIG. 1.

### DETAILED DESCRIPTION

One or more embodiments of the subject matter described herein provide systems and methods for planning the concurrent movement of plural vehicles in a transportation network. The vehicles may move in the transportation network according to schedules that direct where and/or when the vehicles travel to various locations. During travel, one or more of the vehicles and/or routes over which the vehicles travel may encounter or experience one or more problems and, as a result, can enter into a failure mode or a failure condition. The terms “failure mode” and “failure condition” may be used interchangeably herein. Examples of failure conditions include vehicle failure (where a vehicle enters into a failure condition), route failure (where a route or section of a route enters into a failure condition), and regulatory failure (where a vehicle or route no longer complies with one or more laws or regulations governing travel in the transportation network). The failure condition is associated with limitations on travel in the transportation network, such as when a vehicle experiences mechanical breakdown, a section of a route is damaged, or a vehicle is violating one or more regulations related to safety of the vehicles.

When a failure condition is identified, the failure condition can be categorized. For example, different failure conditions can be associated with different categories, such as mechanical breakdowns, reduced tractive output from a vehicle, unusable sections of a route, and the like. The different categories of failure conditions can be associated with different sets of remedial actions. The remedial actions represent different operations that can be taken in order to plan or adjust the movement of the vehicles in the transportation network. The remedial actions can present different options to an operator disposed off-board the vehicles in order to coordinate the continued movement of the vehicles in response to identification of the failure condition. For example, an operator at a dispatch center can change the schedules of vehicles in the transportation network when one of the vehicles mechanically breaks down or a section of a route is damaged.

Potential consequences to taking the different remedial actions can be determined and presented to the operator. The potential consequences can indicate probable outcomes from implementing the different remedial actions. For example, the changes in the flow of movement of other vehicles when a first remedial action is taken versus taking a different, second remedial action can be determined. These consequences can be determining using one or more computer simulations on travel of the vehicles when the various remedial actions are potentially implemented. In one embodiment, continued travel of the vehicles is monitored and factored into the determination of the potential consequences that are presented to the operator. For example, movement of the vehicles after identification of the failure condition may be monitored and included in the simulations of taking the various remedial actions. The movement of the vehicles is monitored and provided as feedback so that the potential consequences are updated in real time, such as during the movement of the vehicles.

The operator may then select one or more of the remedial actions to implement based on a comparison of the potential consequences. For example, based on a comparison of how significant slowdowns in the travel of other vehicles will be when a first remedial action is implemented versus a different, second remedial action, the operator may select the remedial action having the smaller slowdown in the flow of travel in the transportation network. Alternatively, the selection of the remedial actions to be implemented may be performed automatically based on a comparison of the potential consequences associated with the remedial actions.

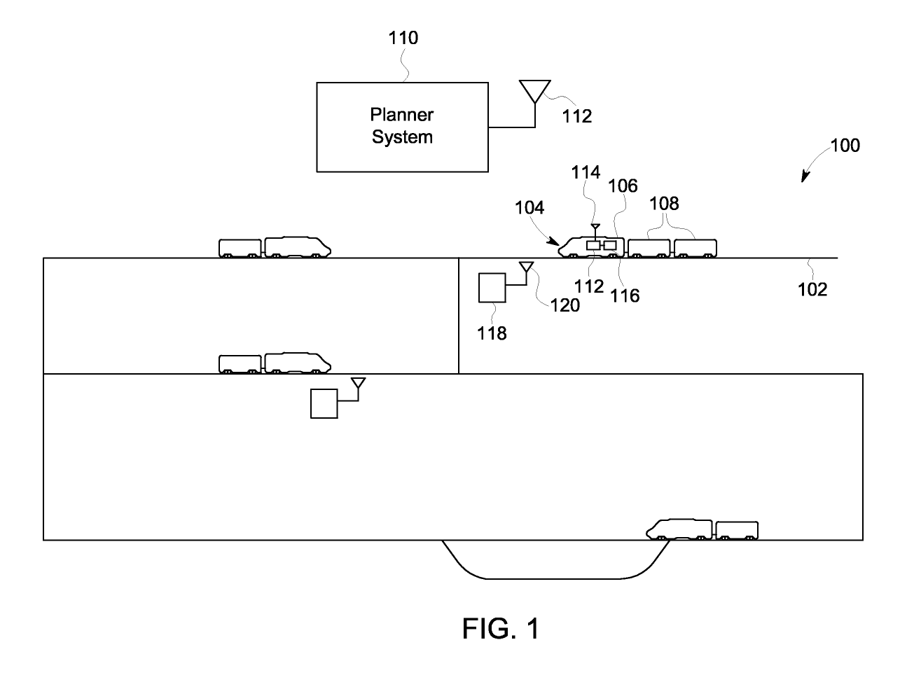

FIG. 1 is a schematic diagram of one embodiment of a transportation network 100. The transportation network 100 includes a plurality of interconnected routes 102. While only one transportation network 100 is shown in FIG. 1, one or more other transportation networks 100 may be joined with and accessible to vehicles traveling in the illustrated transportation network 100. For example, one or more of the routes 102 may extend to another transportation network 100 such that vehicles can travel between the transportation networks 100. Different transportation networks 100 may be defined by different geographic boundaries, such as different towns, cities, counties, states, groups of states, countries, continents, and the like.

Several vehicles 104 travel along the routes 102 in the transportation network 100. The vehicles 104 may concurrently travel in the transportation network 100 along the same or different routes 102. Travel of one or more vehicles 104 may be constrained to travel within the transportation network 100 (referred to herein as “intra-network travel”). Alternatively, one or more of the vehicles 104 may enter the transportation network 100 from another transportation network or leave the transportation network 100 to travel into another transportation network (referred to herein as “inter-network travel”). In the illustrated embodiment, the vehicles 104 are shown and described herein as rail vehicles or rail vehicle consists. However, one or more other embodiments may relate to vehicles other than rail vehicles or rail vehicle consists. For example, one or more of the vehicles 104 may represent other off-highway vehicles, automobiles, airplanes, marine vessels, and the like, and the routes 102 may represent other pathways of travel, such as roads, airline pathways, marine shipping pathways, and the like. In one embodiment, plural different types of vehicles 104 may concurrently travel in the transportation network 100 formed from different types of routes 102. For example, a mining vehicle (e.g., a first vehicle 104) may travel on a road (e.g., a first route 102) toward a location in the transportation network 100 where the mining vehicle meets a rail vehicle (e.g., a second vehicle 104), which then travels along a track (e.g., a second route 102) to a port in the transportation network 100 to meet a marine vessel (e.g., a third vehicle 104), which travels to another port. While four vehicles 104 are shown, alternatively, a different number of vehicles 104 may be used. A vehicle 104 may include a group of powered units 106 (e.g., locomotives or other vehicles capable of self-propulsion) and/or non-powered units 108 (e.g., cargo cars, passenger cars, or other vehicles incapable of self-propulsion) that are mechanically coupled or linked together to travel along the routes 102.

The vehicles 104 may move in the transportation network 100 according to a movement plan, such as a set of schedules that are coordinated with each other. The schedules of the vehicles 104 may be dependent on each other. As one example, two or more trains may need to coordinate schedules so that the trains can arrive at the same location in order to exchange cargo. As another example, different vehicles 104 may need to meet up with each other to exchange cargo, such as when a mining vehicle transports mined materials to a train, which transports the materials to a marine vessel, which then transports the materials to another location.

The schedules of the vehicles 104 can dictate starting times, starting locations, arrival times, destination locations, paths, and the like. The starting times and starting locations can represent the times and locations where the vehicles 104 begin associated trips. The arrival times and destination locations can represent the times at which the vehicles 104 are to arrive at or pass by various locations. The destination locations may represent the final locations to which the vehicles 104 are traveling toward, or may represent one or more intermediate locations on the way to the final destination. The paths can represent which routes 102 and/or sections of the routes 102 are to be taken by the vehicles 104 to travel in the transportation network 100.

A planner system 110 can monitor and plan (e.g., coordinate) the movements of the vehicles 104 in the transportation network 100. In one embodiment, the planner system 110 may generate the schedules of the vehicles 104 and/or modify the schedules as the vehicles 104 are moving. The planner system 110 can include one or more devices, controllers, and the like, having hardware and/or software components that operate to provide various functions described herein. As shown in FIG. 1, the planner system 110 can be disposed off-board (e.g., outside) the vehicles 104. For example, the planner system 110 may be disposed at a central dispatch office for a railroad company. The planner system 110 can include a wireless antenna 112, such as a radio frequency (RF) or cellular antenna, along with associated transceiving circuitry, that wirelessly transmits schedules and/or modifications to the schedules to the vehicles 104. For example, the planner system 110 may transmit destination locations and associated arrival times to the vehicles 104. Alternatively, the planner system 110 may communicate the schedules to the vehicles 104 via another medium, such as through one or more conductive pathways (e.g., wires, cables, the rails of a railroad track, an overhead catenary, or the like).

The vehicles 104 include control systems 112 disposed on-board the vehicles 104. The control systems 112 may include one or more computer processors, controllers, control units, or other logic-based devices, and/or associated sets of instructions (e.g., software). The control systems 112 receive the schedules and/or modifications to the schedules from the planner system 110 and generate control signals that may be used to control propulsion of the vehicles 104. For example, the vehicles 104 may include wireless antennas 114, such as RF or cellular antennas, along with associated transceiving circuitry, that receive the schedules and/or modifications to the schedules from the planner system 110. The control systems 112 on the vehicles 104 examine the schedules and/or modifications and generate control signals based on the schedules.

The vehicles 104 include propulsion subsystems 116, such as engines, traction motors, brake systems, and the like, that generate tractive effort to propel the vehicles 104 and braking effort to slow down or stop movement of the vehicles 104. The control signals generated by the control systems 112 may be used to automatically control tractive efforts and/or braking efforts provided by the propulsion subsystems 116 such that the vehicle 104 self-propels along the routes 102. The control signals may automatically control the propulsion subsystems 116, such as by automatically changing throttle settings and/or brake settings of the propulsion subsystems 116. Alternatively, the control signals may be used to prompt an operator of the vehicle 104 to manually control the tractive efforts and/or braking efforts of the vehicle 104. For example, the control system 112 may include an output device, such as a computer monitor, touchscreen, acoustic speaker, or the like, that generates visual and/or audible instructions based on the control signals. The instructions may direct the operator to manually change throttle settings and/or brake settings of the propulsion subsystem 116 of the vehicle 104.

Although not shown in FIG. 1, the vehicles 104 may include sensors, such as on-board sensors, that monitor operational parameters of the vehicles 104. For example, a sensor may monitor tractive efforts provided by the vehicle 104 (e.g., horsepower), braking effort or capability of the vehicle 104 (e.g., brake air pressures), speed of the vehicle 104, engine temperature, brake temperature, fuel level, coupling forces between units 106, 108 of a vehicle 104, and the like, that represent quantifiable measures representative of movement and operations of the vehicle 104. The sensor may be used to monitor the operational parameters to determine if and/or when a vehicle 104 enters a failure condition, as described above. For example, the sensor can communicate the operational parameters to the planner system 110 and/or may communicate an identification of a failure condition to the planner system 110 using the antenna 114.

Several wayside devices 118 may be disposed in the transportation network 100 alongside or otherwise near the routes 102. The wayside devices 118 can include sensors, such as off-board sensors, that also monitor operational parameters of the vehicles 104 and/or the routes 102. For example, the wayside devices 118 can include sensors that monitor speeds of vehicles 104, axle or bearing temperatures of the vehicles 104, brake temperatures of the vehicles 104, vibrations caused by the vehicles 104, one or more physical characteristics or conditions of the routes 102 (e.g., the coefficient of friction of a route, temperature of or around the route, damage to a route, displacement of the route from a previous location), and the like. The sensor can be used to monitor the operational parameters of the vehicles 104 and/or routes 102 to determine if one or more vehicles 104 and/or routes 102 enter into a failure condition, as described above.

The wayside devices 118 may include wireless antennas 120, such as RF or cellular antennas, along with associated transceiving circuitry, that communicate with the vehicles 104 and/or planner system 110. The wayside devices 118 can communicate the operational parameters and/or an identification of a failure condition to the vehicles 104 and/or the planner system 110.

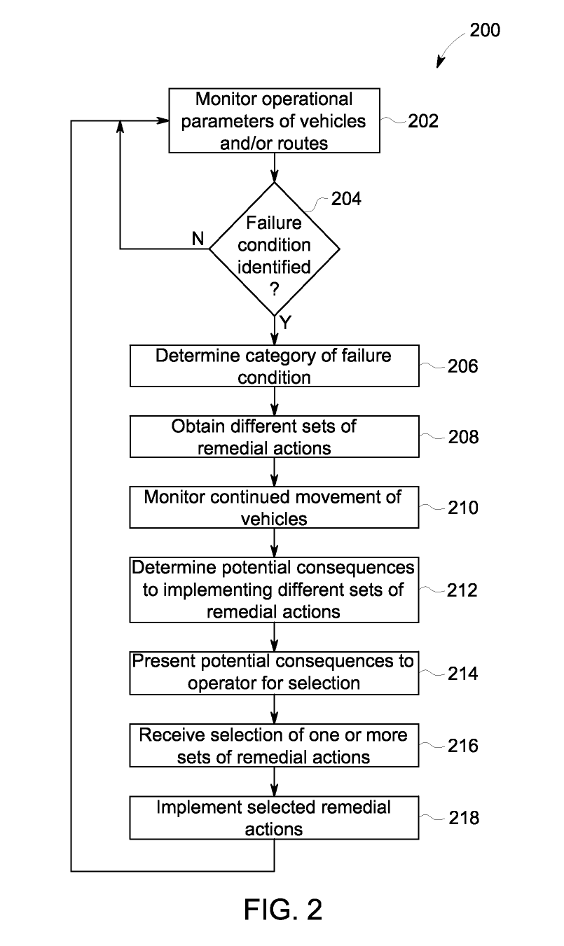

FIG. 2 is a flowchart of one embodiment of a method 200 for planning concurrent movements of vehicles traveling in a transportation network. The method 200 may be used in conjunction with one or more embodiments of the planner system 110, vehicles 104, and wayside devices 118 shown in FIG. 1.

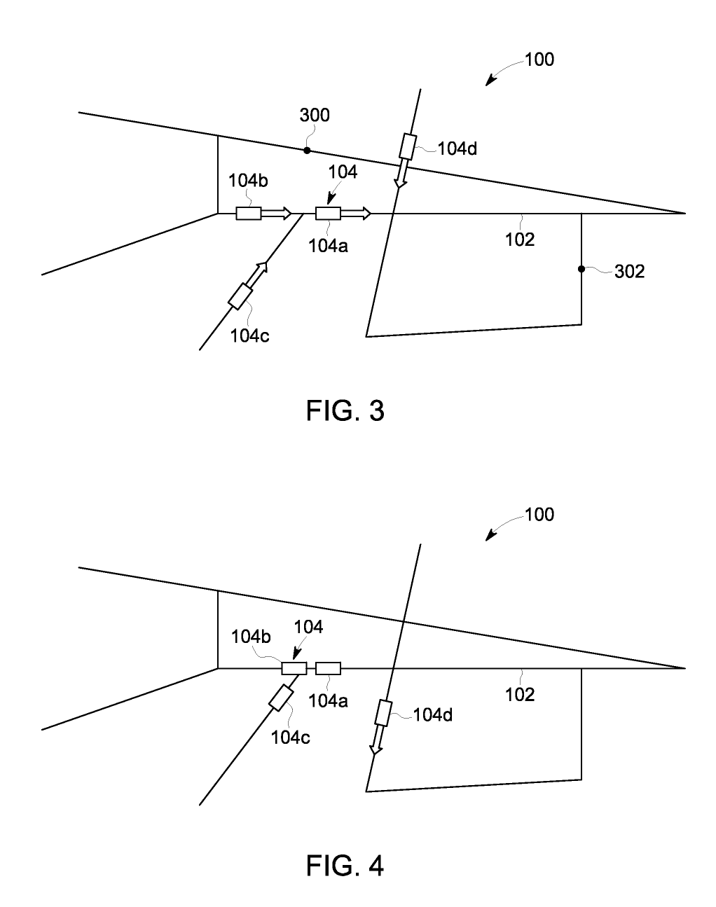

With continued reference to the method 200 shown in FIG. 2, FIGS. 3 through 8 are schematic diagrams of the transportation network 100 during simulations of travel of the vehicles according to different sets of remedial actions. The diagrams in FIGS. 3 through 8 may represent the locations of several vehicles 104a, 104b, 104c, 104d in the transportation network 100, as well as arrows shown next to the vehicles 104 that represent directions of travel of the vehicles 104 along the routes 102 in the transportation network 100. The diagrams of FIGS. 3 through 8 are used to illustrate one example of performing the method 200 shown in FIG. 2 when a failure condition associated with a first vehicle 104a is identified. The example illustrated in FIGS. 3 through 8 is referred to herein as the “vehicle failure example.”

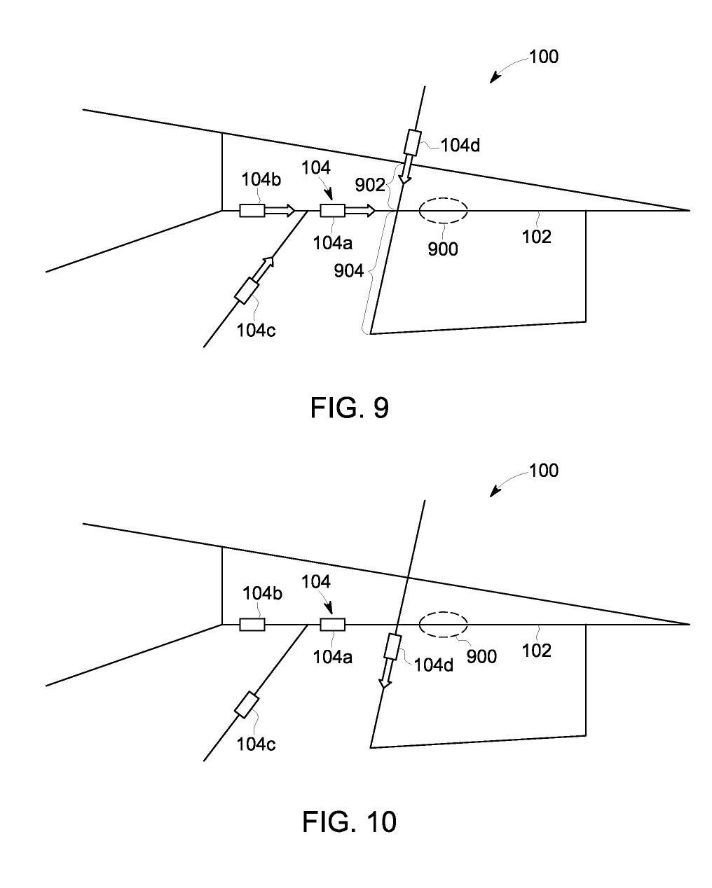

FIGS. 9 through 14 are schematic diagrams of the transportation network 100 at different times during a different, second example of the method 200. The diagrams in FIGS. 9 through 14 may represent the locations of several vehicles 104a, 104b, 104c, 104d in the transportation network 100, as well as arrows shown next to the vehicles 104 that represent directions of travel of the vehicles 104 along the routes 102 in the transportation network 100. The diagrams of FIGS. 9 through 14 are used to illustrate another example of performing the method 200 shown in FIG. 2 when a failure condition associated with a route 102 is identified. The example illustrated in FIGS. 9 through 14 is referred to herein as the “route failure example.”

At 202, operational parameters of vehicles and/or routes in the transportation network are monitored. For example, on-board sensors disposed on the vehicles 104 and/or off-board sensors disposed outside the vehicles 104 (e.g., at the wayside devices 118 shown in FIG. 1) may measure operational parameters related to the vehicles 104, routes 102, and/or laws or other regulations that limit travel of the vehicles 104. With respect to the vehicles 104, the operational parameters may include speeds at which the vehicles 104 are moving, tractive efforts that are output or provided by the vehicles 104 (e.g., horsepower produced), braking efforts or braking capacity (e.g., brake air pressures) of the vehicles 104, engine temperatures, brake temperatures, electric current demanded by traction motors, coupling forces between units of the vehicles 104, bearing temperatures, wheel temperatures, and the like.

With respect to the routes 102 (shown in FIG. 1), the operational parameters may include an amount or degree of damage to one or more sections of the routes 102 (e.g., broken sections, separated sections, and the like), a coefficient of friction of the routes 102 (e.g., a measurement of how slippery the route 102 is due to, among other causes, weather), and the like. With respect to laws and other regulations that limit travel of the vehicles 104, the operational parameters can represent deviations or differences between actual movements of the vehicles 104 and the laws or regulations. For example, an operational parameter may represent a speed that a vehicle 104 is traveling over or under a speed limit, an amount of time that a vehicle 104 remains stationary over or under a time limit (e.g., as a crossing signal), an amount of emissions generated by the vehicle 104 that exceeds or falls below an emissions limit, a difference in weight of the vehicle 104 and a weight limit, and the like.

At 204, a determination is made as to whether the operational parameters that are monitored identify a failure condition. The operational parameters associated with the vehicles 104 and/or routes 102 may be compared to one or more designated thresholds to identify a failure condition. For example, if an operational parameter exceeds or falls below a designated threshold (e.g., a speed limit, temperature limit, air pressure limit, emissions limit, coefficient of friction limit, damage limit, and the like), then the operational parameter of the vehicle 104 or route 102 may indicate a failure condition of the vehicle 104 or route 102.

In the vehicle failure example illustrated in FIGS. 3 through 8, a failure condition of the first vehicle 104a may be identified at or prior to the point in time illustrated in FIG. 3. The failure condition may be a decreased tractive output (e.g., decreased horsepower) from the first vehicle 104a.

In the route failure example illustrated in FIGS. 9 through 14, a failure condition of the route 102 may be identified at or prior to the point in time illustrated in FIG. 3. The failure condition may be a damaged section 900 of the route 102.

If a failure condition is identified based on the operational parameters, then the movements of one or more of the vehicles 104 may need to be modified due to the state or condition of the vehicles 104 and/or routes 102 associated with the operational parameters. With respect to the vehicle failure example, the movements of the vehicles 104b, 104c, 104d may need to be modified in order to account for the slower or stopped movement of the first vehicle 104a shown in FIG. 3. With respect to the route failure example, the movements of the vehicles 104a, 104b, 104c that are scheduled to travel over or through the damaged section 900 of the route 102 may need to be modified in order to account for the damage to the route 102. As a result, flow of the method 200 continues to 206. Otherwise, flow of the method 200 may return to 202, where the operational parameters of the vehicles 104 and/or routes 102 continue to be monitored.

At 206, a category of the failure condition that is identified is determined. The various failure conditions that may be associated with the vehicles 104 and/or routes 102 may be grouped into different categories. Each category may include those failure conditions that are similar to each other or that are related to the same cause of the failure condition. For example, those failure conditions that are indicative of decreased tractive output of the vehicle 104 (e.g., horsepower being below a threshold or speed being below a threshold) may be in a first category. The failure conditions that are indicative of an unsafe condition of the vehicle 104 (e.g., overheated bearings, wheels, or axles; low air brake pressures; excess coupling forces; and the like) may be in a second category. The failure conditions that are indicative of damage to the route 102 may be in a third category. Other failure conditions may be grouped into other categories. The category to which the identified failure condition belongs may be determined by reference to a list, table, database, or other memory structure that associates the failure conditions with the different categories. A single failure condition may be associated with, or belong, to different categories. For example, two or more categories can have one or more failure conditions that are in common.

In one embodiment, the grouping of the failure conditions into categories may be customizable. For example, different operators of the planner system 110 (shown in FIG. 1) may establish different failure conditions (such as the thresholds used to identify the failure conditions) and/or the categories of the failure conditions.

At 208, different sets of remedial actions are obtained. The sets of remedial actions may be predetermined, such as by creating the remedial actions and/or grouping the remedial actions into the sets before the failure condition is identified. The sets of remedial actions may be obtained from a location where the sets are stored, such as in a table, list, database, or other memory structure.

The sets of remedial actions may be acquired based on the category to which the identified failure condition belongs. For example, each category may be associated with multiple sets of remedial actions. When the category of the failure condition is determined, the corresponding sets of remedial actions may be obtained. The sets of remedial actions may be associated with the different categories using a list, table, database, or other memory structure that associates the sets of remedial actions with the categories.

A set of remedial actions may include one or more operations, steps, or actions that are to be taken with respect to the movements of one or more vehicles 104 in the transportation network 100. For example, a set of remedial actions may include a single operation or a series of operations to be sequentially performed to control or change the movements of the vehicles 104. A set of remedial actions can be referred to as a “workflow,” “operating procedure,” or “standard operating procedure” to be followed in order to control or change movements of the vehicles 104. The remedial actions of each set can be referred to as “solutions,” as the remedial actions may present various options that can be taken to resolve one or more problems with travel in the transportation network 100, such as a broken down vehicle 104, a damaged section of a route 102, and the like.

Different sets of remedial actions can include different operations. With respect to the vehicle failure example of FIGS. 3 through 6, a category of failure conditions related to the first vehicle 104a may be associated with a first set of remedial actions that include an operator (e.g., a dispatcher) at the planner system 110 (shown in FIG. 1) directing the first vehicle 104a to be put out of service immediately or as soon as practical (e.g., to stop movement at the current location of the first vehicle 104a as shown in FIG. 3 and remain stationary on the route 102 until help or service arrives). A different, second set of remedial actions can include the operator directing the first vehicle 104a to continue moving in order to travel to a service location 300 (shown in FIG. 3), such as a platform, service station, or other geographic position for repair or service. A different, third set of remedial actions can include the operator directing the first vehicle 104a to continue moving toward a scheduled destination location 302 (shown in FIG. 3), but at a reduced speed. One or more of the sets can include a single remedial action, or several remedial actions.

With respect to the route failure example of FIGS. 9 through 14, a category of failure conditions related to the route 102 can be associated with a first set of remedial actions can include the operator at the planner system 110 (shown in FIG. 1) directing the vehicles 104a, 104b, 104c that are scheduled to travel over the damaged section 900 to stop movement at the current locations of the vehicles 104a, 104b, 104c or as soon as practical. A second set of remedial actions associated with the category can include the operator directing the vehicles 104a, 104b, 104c scheduled to travel over the damaged section 900 to change paths or destination locations so as to avoid traveling over the damaged section 900 of the route 102. For example, one or more of the vehicles 104a, 104b, 104c may be directed to move onto an alternate section 902 or 904 of the routes 102 in order to travel around, and not over, the damaged section 900. A third set of remedial actions can include the operator directing the vehicles 104a, 104b, 104c scheduled to travel over the damaged section 900 of the route 102 to continue to travel toward and over the damaged section 304, but at reduced speeds.

Other sets and/or types of remedial actions can be used. The above examples are not intended to be limiting on all embodiments described herein. Additionally, in one embodiment, the remedial actions and/or sets of remedial actions can be customizable. For example, an operator at the planner system 110 (shown in FIG. 1) can create and/or modify the remedial actions and/or sets of the remedial actions as desired.

At 210, continued movement of the vehicles 104 in the transportation network 100 is monitored. For example, the planner system 110 (shown in FIG. 1) may track the movements of the vehicles 104 after the failure condition is identified. The planner system 110 may continue to monitor movements of the vehicles 104 so as to enable an educated selection of one or more of the remedial actions to be implemented, as described below. By “educated selection,” it is meant that the selection of a set of remedial actions to be implemented may be made based on the information related to the continued movements of the vehicles 104 that are tracked after identification of the failure condition.

The movement of the vehicles 104 may continue to be tracked in real-time, such as during the actual movements of the vehicles 104. The movements of the vehicles 104 can be monitored during the time periods in which the category of the failure condition is identified (at 206), the different sets of remedial actions are obtained (at 208), and/or the decision as to which sets of remedial actions are selected for implementation (described below).

The movement of the vehicles 104 may be tracked using self-reporting from the vehicles 104 and/or external monitoring of the vehicles 104. Self-reporting can include sensors on the vehicles 104 (e.g., Global Positioning System receivers, speed sensors, transponders, and the like) that determine the position of the vehicles 104 and/or information used to determine the location of the vehicles 104 (e.g., by using the speed and time since passing a known position, by determining when the vehicle 104 passes over a transponder on or near a route 102 at a known location, and the like). The positions of the vehicles 104 (or other information that is used to determine the positions) can be transmitted from the vehicles 104 to the planner system 110 (shown in FIG. 1). External monitoring can include the wayside devices 118 (shown in FIG. 1) reporting the passage of the vehicles 104 by the wayside devices 118 to the planner system 110, or other sensors disposed outside of the vehicles 104 reporting when and where the vehicles 104 move.

At 212, potential consequences to implementing the remedial actions of the different sets are determined. The potential consequences can include the potential impact of actually performing the operations of the remedial actions on the travel of the vehicles 104 in the transportation network 100. The potential consequences can be based on simulated travel of the vehicles 104 that incorporates the different remedial actions.

For example, one or more computer software applications or systems can simulate the movements of the vehicles 104 in the transportation network 100. The simulations may run based on movement data of the vehicles 104, such as the current or last known locations of the vehicles 104, directions of travel of the vehicles 104, speeds of the vehicles 104, locations of the routes 102, intersections of the routes 102, the scheduled paths to be taken by the vehicles 104, the scheduled destination locations of the vehicles 104, the scheduled arrival times of the vehicles 104, and/or the modified movements, paths, destination locations, or arrival times as dictated by the set of remedial actions being simulated. In one embodiment, the simulations may be updated based on current movements of the vehicles 104. For example, while the simulations are being performed to determine where and when the vehicles 104 are likely to move or will move if the set of remedial actions is implemented, the planner system 110 (shown in FIG. 1) may update the simulated movements of the vehicles 104 with the actual movements of the vehicles 104 as the vehicles 104 continue to move in the transportation network 100. Updating the simulations with the actual continued movements of the vehicles 104 can provide an operator with more accurate information on the potential consequences of implementing a set of remedial actions on the movements of the vehicles 104 in the transportation network 100.

With respect to the vehicle failure example, a first simulation may be performed using the monitored movements of the vehicles 104 subsequent to identification of the failure condition and implementation of the first set of remedial actions that involves directing the first vehicle 104a to be put out of service at the current location of the first vehicle 104a (e.g., the position shown in FIG. 3). The first simulation may estimate the movements of the vehicles 104b, 104c, 104d in the transportation network 100 when the first vehicle 104a stops at the location shown in FIG. 3.

FIG. 4 illustrates a schematic diagram of the transportation network 100 in accordance with the vehicle failure example of the method 200. The diagram of FIG. 4 shows the simulation of implementing the first remedial action (e.g., directing the first vehicle 104a to stop at its current location. The other vehicles 104b, 104c, 104d continue to move in the first simulation from the respective positions shown in FIG. 3 to the positions shown in FIG. 4. The stopped movement of the first vehicle 104a has slowed or stopped movement of the second and third vehicles 104b, 104c, as shown in FIG. 4. The stopped movement of the first vehicle 104a did not, however, cause the fourth vehicle 104d to stop in the first simulation.

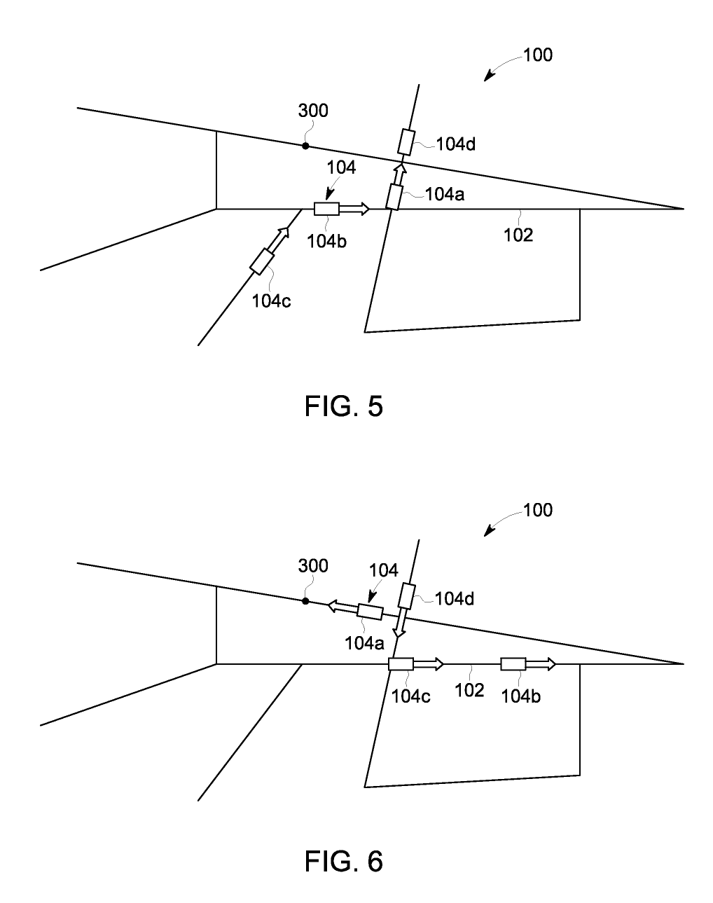

A second simulation may be performed using the monitored movements of the vehicles 104 and implementation of the second set of remedial actions (e.g., directing the first vehicle 104a to travel to the service location 300 for repair). FIGS. 5 and 6 illustrate additional schematic diagrams of the transportation network 100 in accordance with the vehicle failure example of the method 200. The diagrams of FIGS. 5 and 6 show the simulation of implementing the second remedial action in the vehicle failure example. FIGS. 5 and 6 illustrate positions and directions of movement of the vehicles 104 at different points in time, with the locations shown in of FIG. 6 being subsequent to those shown in FIG. 5.

As shown in FIGS. 5 and 6, the first vehicle 104a changes which sections of the routes 102 are followed in order to travel toward the service location 300 instead of the destination location 302. Due to the change in the path traveled by the first vehicle 104a, the fourth vehicle 104d may be required to slow down and/or stop to allow the first vehicle 104a to travel to the service location 300, as shown in FIG. 5, before continuing to move, as shown in FIG. 6. The second and third vehicles 104b, 104c may continue toward associated destination locations.

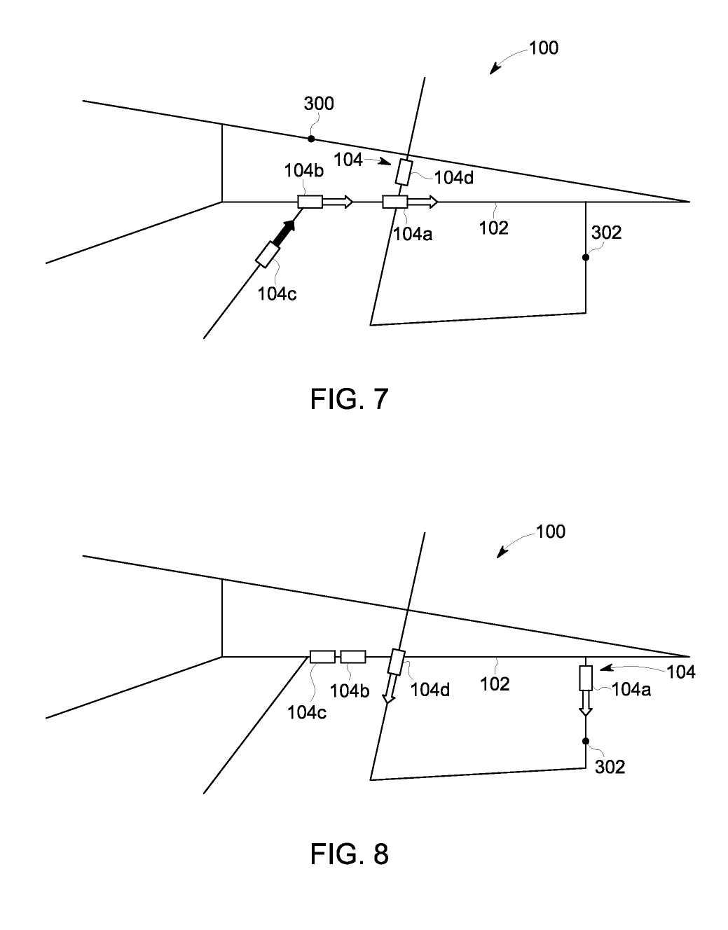

A third simulation may be performed using the monitored movements of the vehicles 104 and implementation of the third set of remedial actions (e.g., directing the first vehicle 104a to travel to the destination location 302 at a slower speed). FIGS. 7 and 8 illustrate additional schematic diagrams of the transportation network 100 in accordance with the vehicle failure example of the method 200. The diagrams of FIGS. 7 and 8 show a third simulation of implementing the third remedial action in the vehicle failure example. FIGS. 7 and 8 illustrate positions and directions of movement of the vehicles 104 at different points in time, with the locations shown in of FIG. 8 being subsequent to those shown in FIG. 7.

As shown in FIGS. 7 and 8, the first vehicle 104a slows down and, as a result, the fourth vehicle 104d may be required to slow and/or stop (as shown in FIG. 7) before continuing on (as shown in FIG. 8). Additionally, the second and third vehicles 104b, 104c may be required to slow down and/or stop (as shown in FIG. 8) to allow the fourth vehicle 104d to safely pass in front of the second and third vehicles 104b, 104c. Subsequent to the positions shown in FIG. 8, the second and third vehicles 104b, 104c may resume travel toward associated destination locations.

For example, with respect to the vehicle failure example, a first simulation may be performed using the monitored movements of the vehicles 104 subsequent to identification of the failure condition and implementation of the first set of remedial actions that involves directing the first vehicle 104a to be put out of service at the current location of the first vehicle 104a (e.g., the position shown in FIG. 3). The first simulation may estimate the movements of the vehicles 104b, 104c, 104d in the transportation network 100 when the first vehicle 104a stops at the location shown in FIG. 3.

With respect to the route failure example, a fourth simulation may be performed using the monitored movements of the vehicles 104 subsequent to identification of the failure condition and implementation of the first set of remedial actions (e.g., directing the vehicles 104 scheduled to travel over the damaged section 900 to stop movement at current positions). The first simulation may estimate the movements of the vehicles 104 in the transportation network 100 when the first, second, and third vehicles 104a, 104b, 104c stop at the locations shown in FIG. 9.

FIG. 10 illustrates a schematic diagram of the transportation network 100 in accordance with the route failure example of the method 200. The diagram of FIG. 10 shows the simulation of implementing the first remedial action (e.g., directing the vehicles 104a, 104b, 104c to stop at their current locations. The other vehicle 104d continues to move in the fourth simulation from the position shown in FIG. 9 to the position shown in FIG. 10.

A fifth simulation may be performed using the monitored movements of the vehicles 104 and implementation of the second set of remedial actions associated with the route failure example (e.g., directing the vehicles 104a, 104b, 104c to travel around the damaged section 900 of the route 102). The positions of the vehicles 104 shown in FIG. 10 also may represent the positions of the vehicles 104 when the second set of remedial actions is implemented in the simulation. For example, the first, second, and third vehicles 104a, 104b, 104c may slow down and/or stop to allow the fourth vehicle 104d to get off of the alternate sections 902, 904 of the routes 102.

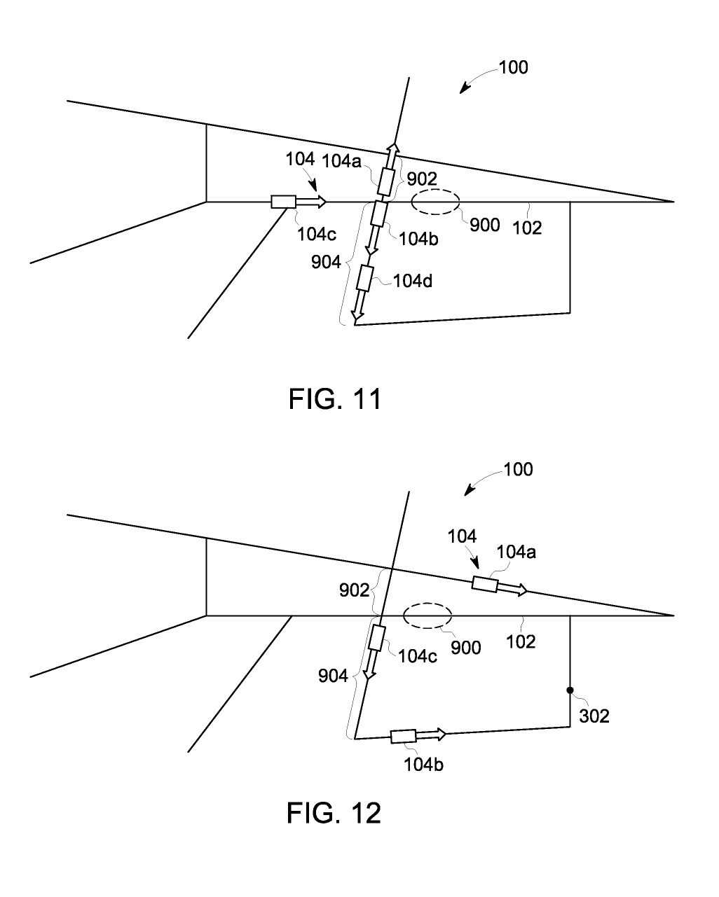

FIGS. 11 and 12 illustrate additional schematic diagrams of the transportation network 100 in accordance with the route failure example of the method 200. The diagrams of FIGS. 11 and 12 show the fifth simulation of implementing the second remedial action in the route failure example (e.g., where the vehicles 104 travel around the damaged section 900). FIGS. 11 and 12 illustrate positions and directions of movement of the vehicles 104 at different points in time, with the locations shown in of FIG. 12 being subsequent to those shown in FIG. 11.

As shown in FIGS. 11 and 12, the first, second, and third vehicles 104a, 104b, 104c change which sections of the routes 102 are followed in order to travel around the damaged section 900. The fourth vehicle 104d is not visible in FIG. 12 due to the fourth vehicle 104d leaving the transportation network 100. Due to the change in the path traveled by the vehicles 104a, 104b, 104c, the vehicles 104b, 104c may arrive at the destination location 302 later than originally scheduled and/or the destination location of the vehicle 104a may be changed to another location.

A sixth simulation may be performed using the monitored movements of the vehicles 104 and implementation of the third set of remedial actions (e.g., directing the vehicles 104a, 104b, 104c to travel over the damaged section 900 of the route 102 at a slower speeds).

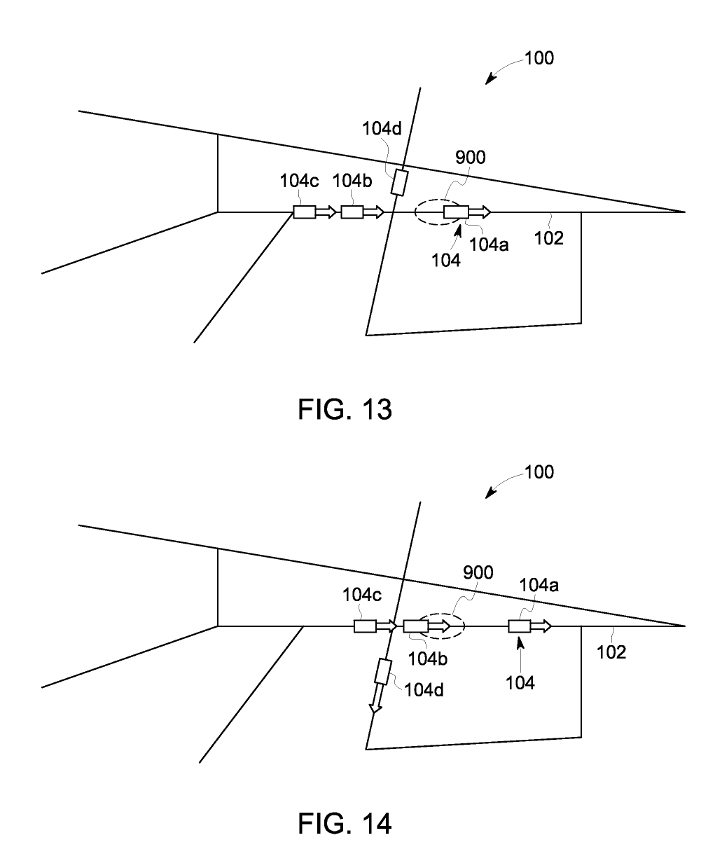

FIGS. 13 and 14 illustrate additional schematic diagrams of the transportation network 100 in accordance with the route failure example of the method 200. The diagrams of FIGS. 13 and 14 show a sixth simulation of implementing the third remedial action in the route failure example (e.g., directing the vehicles 104a, 104b, 104c to travel more slowly through the damaged section 900 of the route 102). FIGS. 13 and 14 illustrate positions and directions of movement of the vehicles 104 at different points in time, with the locations shown in of FIG. 14 being subsequent to those shown in FIG. 13.

As shown in FIGS. 13 and 14, the first, second, and third vehicles 104a, 104b, 104c slow down and, as a result, the fourth vehicle 104d may be required to slow and/or stop (as shown in FIG. 13) before continuing on (as shown in FIG. 14). Additionally, the third vehicle 104c may be required to slow down and/or stop to allow the second vehicle 104b to safely pull in front of the third vehicle 104c. Subsequent to the positions shown in FIG. 14, the vehicles 104 may resume travel toward associated destination locations.

Returning to the discussion of the method 200 shown in FIG. 2, the potential consequences of the different sets of remedial actions may be obtained from the simulations of the remedial actions. The potential consequences may include measurements or estimations of changes or deviations from scheduled travel of the vehicles 104. For example, potential consequences of implementing the remedial actions may be calculated as differences between scheduled times of arrival at destination locations and later times of arrival at the same destination locations that are estimated from the simulations. Alternatively, the potential consequences can include vehicle densities (e.g., number of vehicles per unit area) in one or more areas of the transportation network 100 that are estimated from the simulations. In another example, differences in amounts of fuel consumed and/or emissions generated by the vehicles 104 that are calculated from travel according to the schedules and according to the simulated travel may represent potential consequences. For example, estimations may be performed on how much more fuel or emissions are generated when the vehicles 104 travel according to the simulations versus according to the original schedules. Alternatively, the potential consequences may include the average, median, or other statistical measure of the estimated speeds of the vehicles 104 during travel in the simulations. In another embodiment, the simulated movement of the vehicles 104 represents the potential consequences. For example, the slowing and/or stopping of the vehicles 104 and/or the different paths taken by the vehicles 104 in the simulations may be the potential consequences.

At 214, the potential consequences associated with the various sets of remedial actions are presented to an operator for selection of one or more of the sets of remedial actions. For example, the potential consequences can be visually displayed and/or audibly presented to an operator of the planner system 110 (shown in FIG. 1) on an output device of the planner system 110. The operator can then select a set of remedial actions (or plural sets of remedial actions) based on a comparison of the potential consequences. The operator may select the one or more sets of remedial actions for implementation in the actual movements of the vehicles 104 (shown in FIG. 1), as described below.

In one embodiment, the potential consequences may be presented to the operator by displaying a list, table, or other presentation of the potential consequences and associated sets of remedial actions. The table below provides one example of such a presentation of the potential consequences:

| | ΔTOA | Density | ΔFuel | Avg. speed |
|---|---|---|---|---|
| SOP #1 | +120 | +1.5 | +4% | 45 |
| SOP #2 | +110 | +4.2 | +6% | 50 |
| SOP #3 | +20 | +6.5 | +2% | 25 |

The first column of table lists names for different sets of remedial actions that the simulations were based on (“SOP #1,” “SOP #2,” and “SOP #3”). For example, with respect to the vehicle failure example, SOP #1 may represent the set of remedial actions that includes directing the first vehicle 104a to stop movement and wait for service, SOP #2 may represent the set of remedial actions that includes directing the first vehicle 104a to change its destination location to a service location, and SOP #3 may represent the set of remedial actions that includes directing the first vehicle 104a to travel to the originally scheduled destination, but at a slower speed. With respect to the route failure example, SOP #1 may represent the set of remedial actions that includes directing the vehicles 104 scheduled to travel over the damaged section 900 of the route 102 to stop movement and wait for service or repair on the damaged section 900 of the route 102, SOP #2 may represent the set of remedial actions that includes directing the vehicles 104 scheduled to travel over the damaged section 900 to change their paths to avoid the damaged section, and SOP #3 may represent the set of remedial actions that includes directing the vehicles 104 scheduled to travel over the damaged section 900 to travel over the damaged section 900 at slower speeds. Alternatively, one or more of the SOPs may represent sets of remedial actions to be taken when one or more of the vehicles or sections of the routes 102 does not meet a regulation or law. For example, one or more of the SOPs may direct vehicles to change destination locations, scheduled arrival times, paths, and the like, when a vehicle is traveling too fast or too slow (relative to a speed limit), a vehicle remains too long at a crossing signal, a vehicle generates too much emissions and is required to slow down, a section of the routes becomes too slick, and the like.

The second column includes the differences in times of arrival (“ΔTOA”) between the scheduled times of arrival for the vehicles 104 (shown in FIG. 1) and the estimated times of arrival that are calculated for the vehicles 104 based on the simulations of the different sets of remedial actions. The differences in times of arrival may represent the sum total, average, median, or other statistical measure of the differences in times of arrival for all or a subset of the vehicles 104. In the illustrated embodiment, the differences in times of arrival are shown in units of minutes, although other units may be used.

The third column includes the changes in vehicle density (“Density”) between travel of the vehicles 104 (shown in FIG. 1) according to the original schedules and according to the simulated movements of the vehicles 104 for each of the different sets of remedial actions. The changes in vehicle density may represent differences between the expected density (expressed in vehicles per square unit area) if the vehicles travel according to schedules and the simulated movement of the vehicles.

The fourth column includes the changes in fuel consumption (“ΔFuel”) between travel of the vehicles 104 (shown in FIG. 1) according to the original schedules and according to the simulated movements of the vehicles 104 for each of the different sets of remedial actions. The changes in fuel consumption may represent average, median, summed total, or other statistical measures of percentage differences between the amounts of fuel that is expected or calculated to be consumed by the vehicles if the vehicles travel according to schedules and the amounts of fuel that are calculated to be consumed based on the simulated movement of the vehicles. Alternatively, the fourth column may represent changes in the amounts of emissions generated between travel of the vehicles according to the schedules and the simulated travel according to the various sets of remedial actions.

The fifth column includes the average speed (“Avg. speed”) of the vehicles 104 (shown in FIG. 1) according to the original schedules and according to the simulated movements of the vehicles 104 for each of the different sets of remedial actions. Alternatively, the fifth column may include the median speed, deviations in speeds, or other statistical measure of the speeds of the vehicles 104. The average speeds may be expressed in miles per hour, kilometers per hour, or in another unit.

An operator may review the potential consequences and, based on a comparison of the potential consequences, select at least one of the sets of remedial actions. For example, the operator may select the SOP #3 set of remedial actions because of the lower difference in time of arrival and/or the lower amount of fuel consumed relative to the other sets of remedial actions. Alternatively, the operator may select the SOP #1 set of remedial actions because of the lower vehicle density and/or the greater average speed. In another embodiment, the operator may use other criteria for selecting a set of remedial actions.

The potential consequences can be presented to the operator by displaying a map of the transportation network 100 (shown in FIG. 1) and showing the actual and/or simulated movements of the vehicles 104 (shown in FIG. 1). For example, the simulated movements of the vehicles 104 (and as may be updated by the actual movements of the vehicles 104 while the operator is deciding which set of remedial actions to select) may be presented on a map. Several maps may be concurrently or simultaneously presented to the operator, or the operator may toggle between different displays (e.g., screens, tabs, and the like) of different maps showing the simulated movements of the different sets of remedial actions.

In one embodiment, the vehicles 104 may be represented by icons on the maps of the transportation network 100, with the icons having colors and/or changing appearance (e.g., blinking) based on one or more potential consequences associated with the vehicles 104. For example, a vehicle 104 having a much later estimated time of arrival than the scheduled time of arrival in a simulation may be shown in a different color (e.g., red) relative to another vehicle 104 having an estimated time of arrival that is closer to the scheduled time of arrival in the same simulation (with the other vehicle 104 being displayed in another color such as yellow or green).

At 216, a selection of one or more sets of remedial actions is received from the operator. For example, the operator may use an input device of the planner system 110 (shown in FIG. 1) to select a set of remedial actions to be implemented with actual travel of the vehicles 104. Alternatively, a set of remedial actions may be automatically selected according to one or more criteria. The set of remedial actions that is selected may be chosen by selecting the set of remedial actions associated with one or more potential consequences that is lower (e.g., smaller differences in times of arrival) or greater (e.g., larger average speeds) than one or more other sets of remedial actions.

At 218, the selected set of remedial actions is implemented. For example, the selected set of remedial actions can be applied to the schedules of the vehicles. Applying the selected set of remedial actions to the schedules can include changing a scheduled path, destination location, and/or arrival time of one or more of the vehicles. With respect to the vehicle failure example described above, the first set of remedial actions can be implemented by communicating an output signal from the planner system 110 (shown in FIG. 1) to the first vehicle 104a (shown in FIG. 3) that directs the first vehicle 104a to stop moving. The second set of remedial actions can be implemented by communicating an output signal from the planner system 110 to the first vehicle 104a that directs the first vehicle 104a to change the destination location to the service location. The third set of remedial actions can be implemented by communicating an output signal from the planner system 110 to the first vehicle 104a that delays the scheduled arrival time of the first vehicle 104a such that the first vehicle 104a slows down as the first vehicle 104a travels to the destination location.

With respect to the route failure example described above, the first set of remedial actions can be implemented by communicating output signals from the planner system 110 (shown in FIG. 1) to the vehicles 104a, 104b, 104c (shown in FIG. 9) that are scheduled to travel through the damaged section 900 (shown in FIG. 9) of the route 102 (shown in FIG. 9) to stop moving. The second set of remedial actions can be implemented by communicating output signals from the planner system 110 to the vehicles 104a, 104b, 104c that directs the vehicles 104a, 104b, 104c to change the paths taken by the vehicles 104a, 104b, 104c to avoid traveling over the damaged section 900 of the route 102. The third set of remedial actions can be implemented by communicating output signals from the planner system 110 to the vehicles 104a, 104b, 104c that delays the scheduled arrival times of the vehicles 104a, 104b, 104c such that the vehicles 104a, 104b, 104c slow down as the vehicles 104a, 104b, 104c travel to the associated destination locations.

Flow of the method 200 may return to 202, where additional operational parameters of the vehicles 104 and/or the routes 102 continue to be monitored. For example, the method 200 may proceed in a loop-wise manner while the vehicles 104 continue to travel in the transportation network 100.

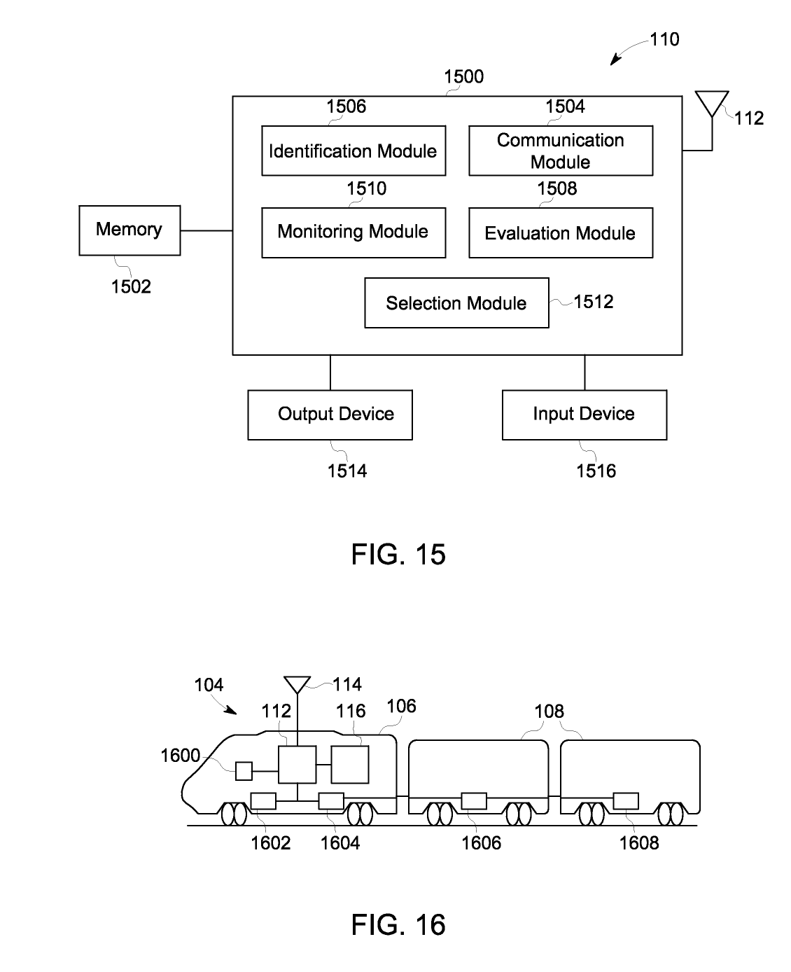

FIG. 15 is a schematic diagram of one embodiment of the planner system 110. The planner system 110 can include a control unit 1500, such as one or more computer processors, controllers, or other logic-based devices. As shown in FIG. 15, the control unit 1500 includes several modules and is communicatively coupled (e.g., connected by one or more wired and/or wireless connections) with a tangible and non-transitory computer readable storage medium, such as a computer memory 1502. As described above, the modules can represent the hardware and/or software (e.g., one or more sets of instructions stored on the memory 1502 and/or hard-wired into the logic of the control unit 1500). The modules may be capable of communicating information (e.g., data or data packets) with each other by wired and/or wireless connections or software interfaces.

A communication module 1504 controls communication with the planner system 110. The communication module 1504 may be communicatively coupled with the antenna 112, associated transceiver circuitry, and/or a wired connection to transmit and/or receive information (e.g., in data packets) with the vehicles 104 (shown in FIG. 1) and/or the wayside devices 118 (shown in FIG. 1), and the like.

An identification module 1506 determines the operational parameters of the vehicles 104 (shown in FIG. 1) and/or the routes 102 (shown in FIG. 1). The identification module 1506 may determine the operational parameters by acquiring or measuring the operational parameters, or by receiving the operational parameters from another source, such as sensors of the vehicles 104 and/or wayside devices 118. The identification module 1506 can determine when a failure condition occurs and/or which category the failure condition belongs. The identification module 1506 can determine the occurrence of a failure condition when operational parameters exceed or fall below one or more designated thresholds, and/or when the occurrence of the failure condition is reported to the identification module 1506 by the vehicles 104 and/or wayside devices 118.

An evaluation module 1508 determines the potential consequences of implementing the different sets of remedial actions. For example, the evaluation module 1508 may obtain the different sets of remedial actions associated with a category of the identified failure condition from the memory 1502. The evaluation module 1508 can simulate movements of the vehicles 104 (shown in FIG. 1) according to the different sets of remedial actions, as described above. The evaluation module 1508 calculates, estimates, or otherwise determines the potential consequences of the different sets of remedial actions, also as described above.

A monitoring module 1510 tracks movements of the vehicles 104 (shown in FIG. 1). The monitoring module 1510 may monitor continued movements of the vehicles 104 after the failure condition is identified and during the time period that the evaluation module 1508 simulates the movements of the vehicles 104. The monitoring module 1510 can report the continued movements to the evaluation module 1508 so that the evaluation module 1508 can update or track the simulations of movement with the actual movements of the vehicles 104.

A selection module 1512 presents an operator with the potential consequences associated with the different sets of remedial actions and/or receives a selection of one or more of the sets of remedial actions to be implemented from the operator. The selection module 1512 can be communicatively coupled with an output device 1514 by one or more wired and/or wireless connections to present the potential consequences to the operator. The output device 1514 can include a monitor, touchscreen, or other display device that visually presents the potential consequences. The selection module 1512 can be communicatively coupled with an input device 1516 by one or more wired and/or wireless connections to receive the selection from the operator of one or more sets of remedial actions to be implemented. The input device 1516 may include a keyboard, microphone, touchscreen, electronic mouse, joystick, and/or other device, to receive the selection from an operator.

Alternatively, the selection module 1512 may automatically select or recommend a set of remedial actions to be implemented. The selection module 1512 may apply one or more criteria to select or recommend the set of remedial actions, such as by comparing the potential consequences and selecting or recommending the set of remedial actions associated with one or more potential consequences that are greater or smaller than one or more other sets of remedial actions.

FIG. 16 is a schematic diagram of one example of the vehicle 104. The powered unit 106 of the vehicle 104 includes the control system 112 communicatively coupled with the propulsion system 116 by one or more wired and/or wireless connections. The vehicle 104 includes several on-board sensors 1600, 1602, 1604, 1606, 1608 that monitor the operational parameters of the vehicle 104. For example, the sensors 1600, 1602, 1604, 1606, 1608 may include temperature sensors, air pressure sensors, force sensors, and the like. In one embodiment, at least one of the sensors 1600, 1602, 1604, 1606, 1608 includes a position determining device, such as a Global Positioning System receiver. The control system 112 can report the operational parameters measured by the sensors 1600, 1602, 1604, 1606, 1608 to the planner system 110 (shown in FIG. 1) using the antenna 114 and associated transceiver circuitry. Alternatively, the control system 112 may examine the operational parameters and determine when a failure condition exists.

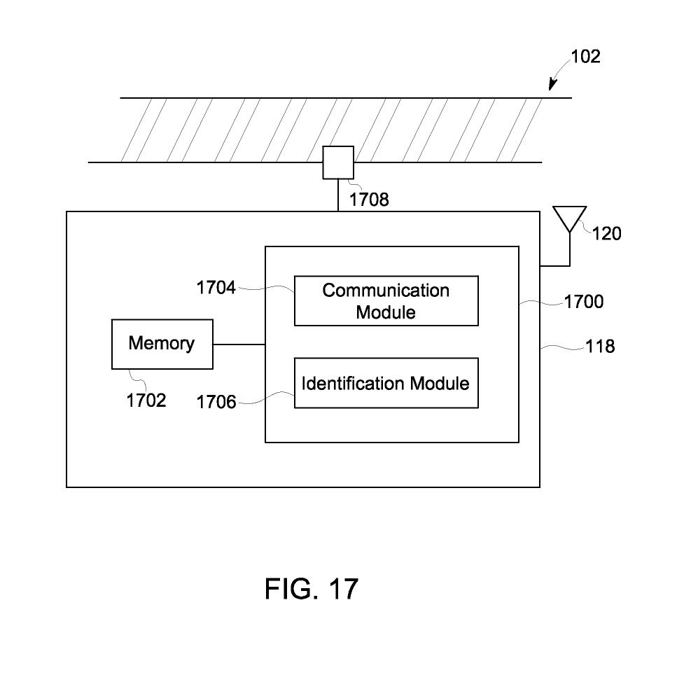

FIG. 17 is a schematic diagram of one embodiment of the wayside device 118. The wayside device 118 can include a control unit 1700, such as one or more computer processors, controllers, or other logic-based devices. As shown in FIG. 17, the control unit 1700 includes several modules and is communicatively coupled (e.g., connected by one or more wired and/or wireless connections) with a tangible and non-transitory computer readable storage medium, such as a computer memory 1702.

A communication module 1704 controls communication with the wayside device 118. The communication module 1704 may be communicatively coupled with the antenna 120, associated transceiver circuitry, and/or a wired connection to transmit and/or receive information (e.g., in data packets) with the planner system 110 (shown in FIG. 1).

An identification module 1706 determines the operational parameters of the vehicles 104 (shown in FIG. 1) and/or the routes 102 (shown in FIG. 1). The identification module 1706 may be communicatively coupled with an off-board sensor 1708 that is disposed at or near the route 102. The sensor 1708 can include an infrared sensor or temperature sensor to measure bearing or wheel temperatures, a force or movement sensor to measure vibrations or movement of the route 102, and the like, to sense the operational parameters. The identification module 1706 can acquire the sensed operational parameters of the vehicles 104 that pass on the route 102 and/or of the route 102. The identification module 1706 can determine when a failure condition occurs and/or which category the failure condition belongs. The identification module 1706 can determine the occurrence of a failure condition when operational parameters exceed or fall below one or more designated thresholds.

In another embodiment, a method (such as a method for planning travel of vehicles in a transportation network) is provided that includes determining an operational parameter of at least one of a first vehicle traveling with a plurality of vehicles in a transportation network or a route in the transportation network, identifying a failure condition of the at least one of the first vehicle or the route based on the operational parameter, obtaining plural different sets of remedial actions that dictate operations to be taken based on the failure condition, simulating travel of the plurality of vehicles in the transportation network based on implementation of the different sets of remedial actions, determining potential consequences on travel of the plurality of vehicles in the transportation network when the different sets of remedial actions are implemented in the travel that is simulated, and, responsive to the potential consequences, receiving a selection of at least one of the different sets of remedial actions to be implemented in actual travel of the plurality of vehicles in the transportation network.

In another aspect, the operational parameter is indicative of at least one of decreased tractive output of the first vehicle, decreased braking output of the first vehicle, violation of one or more laws or regulations by the vehicle, damage to a section of the route, or a change in a physical characteristic of the route.

In another aspect, the operations of the different sets of remedial actions include changes to previously generated schedules of the vehicles, the changes including one or more of a changed path to follow in the transportation network, a changed destination location, a changed arrival time, a changed speed to travel in the transportation network, or a stop in movement.

In another aspect, obtaining the different sets of remedial actions includes determining a category of the failure condition from a plurality of different categories and determining which of the sets of remedial actions are associated with the category that is determined.

In another aspect, the different sets of remedial actions include a first set of remedial actions and a second set of remedial actions, and simulating the travel of the plurality of vehicles includes simulating the travel of the plurality of vehicles if the first set of remedial actions were to be implemented to change movements of one or more of the plurality of vehicles and simulating the travel of the plurality of vehicles if the second set of remedial actions were to be implemented to change the movements of one or more of the plurality of vehicles.

In another aspect, simulating the travel of the plurality of vehicles includes monitoring continued movement of the vehicles subsequent to identifying the failure condition and updating simulation of the travel of the plurality of vehicles based on the movement that is monitored.

In another aspect, the potential consequences include one or more of different times of arrival for one or more of the plurality of vehicles relative to scheduled times of arrival, different speeds of movement of one or more of the plurality of vehicles relative to speeds of movement that are expected based on previously generated schedules of the one or more of the plurality of vehicles, different amounts of fuel consumed or emissions generated by one or more of the plurality of vehicles relative to expected amounts of fuel consumed or emissions generated based on the previously generated schedules, or changes in densities of the plurality of vehicles in the transportation network relative to expected densities of the plurality of vehicles based on the previously generated schedules.

In another aspect, receiving the selection includes presenting the potential consequences associated with implementing the different sets of remedial actions in the travel that is simulated to an operator and receiving the selection from the operator.

In another aspect, receiving the selection includes comparing the potential consequences associated with implementing the different sets of remedial actions in the travel that is simulated and automatically selecting one or more of the different sets of remedial actions based on the potential consequences that are compared.

In another embodiment, a system (such as a system for planning travel of vehicles in a transportation network) is provided that includes an identification module, an evaluation module, and a selection module. The identification module is configured to determine a failure condition of at least one of a first vehicle of a plurality of vehicles traveling in a transportation network or a route in the transportation network. The failure condition is based an operational parameter of the at least one of the first vehicle or the route. The evaluation module is configured to obtain plural different sets of remedial actions that dictate operations to be taken based on the failure condition. The evaluation module also is configured to simulate travel of the plurality of vehicles in the transportation network based on implementation of the different sets of remedial actions and to determine potential consequences on travel of the plurality of vehicles in the transportation network when the different sets of remedial actions are implemented in the travel that is simulated. The selection module is configured to receive a selection of at least one of the different sets of remedial actions to be implemented in actual travel of the plurality of vehicles in the transportation network based on the potential consequences associated with the different sets of remedial actions.

In another aspect, the operational parameter is indicative of at least one of decreased tractive output of the first vehicle, decreased braking output of the first vehicle, violation of one or more laws or regulations by the first vehicle, damage to a section of the route, or a change in a physical characteristic of the route.

In another aspect, the operations of the different sets of remedial actions include changes to previously generated schedules of the vehicles, the changes including one or more of a changed path to follow in the transportation network, a changed destination location, a changed arrival time, a changed speed to travel in the transportation network, or a stop in movement.

In another aspect, the evaluation module is configured to determine a category of the failure condition from a plurality of different categories and determine which of the sets of remedial actions are associated with the category.

In another aspect, the different sets of remedial actions include a first set of remedial actions and a second set of remedial actions, and the evaluation module is configured to simulate the travel of the plurality of vehicles if the first set of remedial actions were to be implemented to change movements of one or more of the plurality of vehicles and to simulate the travel of the plurality of vehicles if the second set of remedial actions were to be implemented to change the movements of one or more of the plurality of vehicles.

In another aspect, the system also includes a monitoring module that is configured to monitor continued movement of the vehicles subsequent to the identification module identifying the failure condition, wherein the evaluation module is configured to update simulation of the travel of the plurality of vehicles based on the movement that is monitored.

In another aspect, the potential consequences include one or more of different times of arrival for one or more of the plurality of vehicles relative to scheduled times of arrival, different speeds of movement of one or more of the plurality of vehicles relative to speeds of movement that are expected based on previously generated schedules of the one or more of the plurality of vehicles, different amounts of fuel consumed or emissions generated by one or more of the plurality of vehicles relative to expected amounts of fuel consumed or emissions generated based on the previously generated schedules, or changes in densities of the plurality of vehicles in the transportation network relative to expected densities of the plurality of vehicles based on the previously generated schedules.

In another aspect, the selection module is configured to present the potential consequences associated with implementing the different sets of remedial actions in the travel that is simulated to an operator and to receive the selection from the operator.

In another aspect, the selection module is configured to compare the potential consequences associated with implementing the different sets of remedial actions in the travel that is simulated and to automatically select one or more of the different sets of remedial actions based on the potential consequences that are compared.

In another embodiment, another system (such as another system for planning travel of vehicles in a transportation network) is provided that includes an identification module, an evaluation module, and a selection module. The identification module is configured to receive operational parameters of at least one of a first vehicle in a plurality of vehicles traveling in a transportation network or a route in the transportation network from one or more sensors disposed on-board the first vehicle or disposed alongside the route. The identification module also is configured to determine a failure condition of at least one of the first vehicle or the route. The evaluation module is configured to obtain a first set of remedial actions and a second set of remedial actions that can be implemented in response to the failure condition that is identified. The first set of remedial actions and the second set of remedial actions dictate different changes on travel of the plurality of vehicles in the transportation network. The evaluation module also is configured to simulate travel of the plurality of vehicles in the transportation network based on implementation of the first set of remedial actions and based on implementation of the second set of remedial actions. The selection module is configured to receive a selection of at least one of the first set of remedial actions or the second set of remedial actions to be implemented in actual travel of the plurality of vehicles in the transportation network based on a comparison of the travel that is simulated by implementing the first set of remedial actions and the travel that is simulated by implementing the second set of remedial actions.

In another aspect, the operational parameter is indicative of at least one of decreased tractive output of the first vehicle, decreased braking output of the first vehicle, violation of one or more laws or regulations by the first vehicle, damage to a section of the route, or a change in a physical characteristic of the route.

In another aspect, the changes of the different sets of remedial actions include changes to previously generated schedules of the vehicles, the changes including one or more of a changed path to follow in the transportation network, a changed destination location, a changed arrival time, a changed speed to travel in the transportation network, or a stop in movement.

In another aspect, the system also includes a monitoring module that is configured to monitor continued movement of the vehicles subsequent to the identification module identifying the failure condition. The evaluation module is configured to update simulation of the travel of the plurality of vehicles based on the movement that is monitored.

In another aspect, the evaluation module is configured to determine potential consequences on the travel of the plurality of vehicles based on the travel that is simulated according to the first set of remedial actions and according to the second set of remedial actions. The potential consequences are representative of changes in the travel of the vehicles that is simulated relative to expected travel of the vehicles that is based on previously generated schedules of the vehicles.

In another aspect, the selection module is configured to present the potential consequences to an operator and to receive the selection from the operator.

In another aspect, the selection module is configured to compare the potential consequences associated with implementing the first set of remedial actions with the potential consequences associated with implementing the second set of remedial actions and to automatically select the first set of remedial actions or the second set of remedial actions based on the potential consequences that are compared.

In another embodiment, another system (e.g., a system for planning movement of vehicles) is provided. The system includes an identification module, an evaluation module, and a selection module. The identification module is configured to determine whether information relating to a first vehicle of a plurality of vehicles in a transportation network, or a route of the transportation network, meets one or more designated criteria for implementing remediation. The evaluation module is configured to obtain plural different remediation plans, responsive to determining that the information meets the one or more designated criteria, implement the remediation plans in simulated travel of the plurality of vehicles in the transportation network, and determine simulated changes in transportation network throughput as a result of implementing the remediation plans in the simulated travel. The selection module is configured to receive a selected one of the remediation plans, for implementation in controlling actual travel of the plurality of vehicles, responsive to the simulated changes in transportation network throughput.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, including the best condition, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A method comprising:
determining an operational parameter of at least one of a first vehicle traveling with a plurality of vehicles in a transportation network or a route in the transportation network;
identifying a failure condition of the at least one of the first vehicle or the route based on the operational parameter;
obtaining plural different sets of remedial actions that dictate operations to be taken based on the failure condition;
simulating travel of the plurality of vehicles in the transportation network based on implementation of the different sets of remedial actions;
determining potential consequences on travel of the plurality of vehicles in the transportation network when the different sets of remedial actions are implemented in the travel that is simulated; and
responsive to the potential consequences, receiving a selection of at least one of the different sets of remedial actions to be implemented in actual travel of the plurality of vehicles in the transportation network.

2. The method of claim 1, wherein the operational parameter is indicative of at least one of decreased tractive output of the first vehicle, decreased braking output of the first vehicle, violation of one or more laws or regulations by the first vehicle, damage to a section of the route, or a change in a physical characteristic of the route.

3. The method of claim 1, wherein the operations of the different sets of remedial actions include changes to previously generated schedules of the vehicles, the changes including one or more of a changed path to follow in the transportation network, a changed destination location, a changed arrival time, a changed speed to travel in the transportation network, or a stop in movement.

4. The method of claim 1, wherein obtaining the different sets of remedial actions includes determining a category of the failure condition from a plurality of different categories and determining which of the sets of remedial actions are associated with the category that is determined.

5. The method of claim 1, wherein the different sets of remedial actions include a first set of remedial actions and a second set of remedial actions, and simulating the travel of the plurality of vehicles includes simulating the travel of the plurality of vehicles if the first set of remedial actions were to be implemented to change movements of one or more of the plurality of vehicles and simulating the travel of the plurality of vehicles if the second set of remedial actions were to be implemented to change the movements of one or more of the plurality of vehicles.

6. The method of claim 1, wherein simulating the travel of the plurality of vehicles includes monitoring continued movement of the vehicles subsequent to identifying the failure condition and updating simulation of the travel of the plurality of vehicles based on the movement that is monitored.

7. The method of claim 1, wherein the potential consequences include one or more of different times of arrival for one or more of the plurality of vehicles relative to scheduled times of arrival, different speeds of movement of one or more of the plurality of vehicles relative to speeds of movement that are expected based on previously generated schedules of the one or more of the plurality of vehicles, different amounts of fuel consumed or emissions generated by one or more of the plurality of vehicles relative to expected amounts of fuel consumed or emissions generated based on the previously generated schedules, or changes in densities of the plurality of vehicles in the transportation network relative to expected densities of the plurality of vehicles based on the previously generated schedules.

8. The method of claim 1, wherein receiving the selection includes presenting the potential consequences associated with implementing the different sets of remedial actions in the travel that is simulated to an operator and receiving the selection from the operator.

9. The method of claim 1, wherein receiving the selection includes comparing the potential consequences associated with implementing the different sets of remedial actions in the travel that is simulated and automatically selecting one or more of the different sets of remedial actions based on the potential consequences that are compared.

10. A system comprising:
an identification module configured to determine a failure condition of at least one of a first vehicle of a plurality of vehicles traveling in a transportation network or a route in the transportation network, the failure condition based on an operational parameter of the at least one of the first vehicle or the route;
an evaluation module configured to obtain plural different sets of remedial actions that dictate operations to be taken based on the failure condition, the evaluation module also configured to simulate travel of the plurality of vehicles in the transportation network based on implementation of the different sets of remedial actions and to determine potential consequences on travel of the plurality of vehicles in the transportation network when the different sets of remedial actions are implemented in the travel that is simulated; and
a selection module configured to receive a selection of at least one of the different sets of remedial actions to be implemented in actual travel of the plurality of vehicles in the transportation network based on the potential consequences associated with the different sets of remedial actions.

11. The system of claim 10, wherein the operational parameter is indicative of at least one of decreased tractive output of the first vehicle, decreased braking output of the first vehicle, violation of one or more laws or regulations by the first vehicle, damage to a section of the route, or a change in a physical characteristic of the route.

12. The system of claim 10, wherein the operations of the different sets of remedial actions include changes to previously generated schedules of the vehicles, the changes including one or more of a changed path to follow in the transportation network, a changed destination location, a changed arrival time, a changed speed to travel in the transportation network, or a stop in movement.

13. The system of claim 10, wherein the evaluation module is configured to determine a category of the failure condition from a plurality of different categories and determine which of the sets of remedial actions are associated with the category.

14. The system of claim 10, wherein the different sets of remedial actions include a first set of remedial actions and a second set of remedial actions, and the evaluation module is configured to simulate the travel of the plurality of vehicles if the first set of remedial actions were to be implemented to change movements of one or more of the plurality of vehicles and to simulate the travel of the plurality of vehicles if the second set of remedial actions were to be implemented to change the movements of one or more of the plurality of vehicles.

15. The system of claim 10, further comprising a monitoring module configured to monitor continued movement of the vehicles subsequent to the identification module identifying the failure condition, wherein the evaluation module is configured to update simulation of the travel of the plurality of vehicles based on the movement that is monitored.

16. The system of claim 10, wherein the potential consequences include one or more of different times of arrival for one or more of the plurality of vehicles relative to scheduled times of arrival, different speeds of movement of one or more of the plurality of vehicles relative to speeds of movement that are expected based on previously generated schedules of the one or more of the plurality of vehicles, different amounts of fuel consumed or emissions generated by one or more of the plurality of vehicles relative to expected amounts of fuel consumed or emissions generated based on the previously generated schedules, or changes in densities of the plurality of vehicles in the transportation network relative to expected densities of the plurality of vehicles based on the previously generated schedules.

17. The system of claim 10, wherein the selection module is configured to present the potential consequences associated with implementing the different sets of remedial actions in the travel that is simulated to an operator and to receive the selection from the operator.

18. The system of claim 10, wherein the selection module is configured to compare the potential consequences associated with implementing the different sets of remedial actions in the travel that is simulated and to automatically select one or more of the different sets of remedial actions based on the potential consequences that are compared.

19. A system comprising:
an identification module configured to receive operational parameters of at least one of a first vehicle in a plurality of vehicles traveling in a transportation network or a route in the transportation network from one or more sensors disposed on-board the first vehicle or disposed alongside the route, the identification module further configured to determine a failure condition of at least one of the first vehicle or the route;
an evaluation module configured to obtain a first set of remedial actions and a second set of remedial actions that can be implemented in response to the failure condition that is identified, the first set of remedial actions and the second set of remedial actions dictating different changes on travel of the plurality of vehicles in the transportation network, the evaluation module also configured to simulate travel of the plurality of vehicles in the transportation network based on implementation of the first set of remedial actions and based on implementation of the second set of remedial actions; and
a selection module configured to receive a selection of at least one of the first set of remedial actions or the second set of remedial actions to be implemented in actual travel of the plurality of vehicles in the transportation network based on a comparison of the travel that is simulated by implementing the first set of remedial actions and the travel that is simulated by implementing the second set of remedial actions.

20. The system of claim 19, wherein the operational parameter is indicative of at least one of decreased tractive output of the first vehicle, decreased braking output of the first vehicle, violation of one or more laws or regulations by the first vehicle, damage to a section of the route, or a change in a physical characteristic of the route.

21. The system of claim 19, wherein the changes of the different sets of remedial actions include changes to previously generated schedules of the vehicles, the changes including one or more of a changed path to follow in the transportation network, a changed destination location, a changed arrival time, a changed speed to travel in the transportation network, or a stop in movement.

22. The system of claim 19, further comprising a monitoring module configured to monitor continued movement of the vehicles subsequent to the identification module identifying the failure condition, wherein the evaluation module is configured to update simulation of the travel of the plurality of vehicles based on the movement that is monitored.

23. The system of claim 19, wherein the evaluation module is configured to determine potential consequences on the travel of the plurality of vehicles based on the travel that is simulated according to the first set of remedial actions and according to the second set of remedial actions, the potential consequences representative of changes in the travel of the vehicles that is simulated relative to expected travel of the vehicles that is based on previously generated schedules of the vehicles.

24. The system of claim 23, wherein the selection module is configured to present the potential consequences to an operator and to receive the selection from the operator.

25. The system of claim 23, wherein the selection module is configured to compare the potential consequences associated with implementing the first set of remedial actions with the potential consequences associated with implementing the second set of remedial actions and to automatically select the first set of remedial actions or the second set of remedial actions based on the potential consequences that are compared.

26. A system comprising:
an identification module configured to determine whether information relating to a first vehicle of a plurality of vehicles in a transportation network, or a route of the transportation network, meets one or more designated criteria for implementing remediation;
an evaluation module configured to:
obtain plural different remediation plans, responsive to determining that the information meets the one or more designated criteria;
implementing the remediation plans in simulated travel of the plurality of vehicles in the transportation network; and
determine simulated changes in transportation network throughput as a result of implementing the remediation plans in the simulated travel; and
a selection module configured to receive a selected one of the remediation plans, for implementation in controlling actual travel of the plurality of vehicles, responsive to the simulated changes in transportation network throughput.
